(19) United States
(12) Patent Application Publication
(10) Pub. No.: US 2011/0139524 A1
(43) Pub. Date: Jun. 16, 2011

(54) METHOD AND DEVICE FOR CONTROLLING A DRIVE TRAIN OF A VEHICLE

(75) Inventors: Detlef Heinrich, Ludwigsburg (DE); Christoph Woll, Gerlingen (DE); Gerhard Filp, Freiberg (DE); Dimitrios Stavrianos, Stuttgart (DE)

(73) Assignee: ROBERT BOSCH GMBH, Stuttgart (DE)

(21) Appl. No.: 12/735,785

(22) PCT Filed: Nov. 19, 2008
(86) PCT No.: PCT/EP2008/065833

§ 371 Date: Feb. 23, 2011

(30) Foreign Application Priority Data
Feb. 20, 2008 (DE) 102008010103.6

(51) Int. Cl. B60W 20/00; B60W 10/06; B60W 10/08

(52) U.S. Cl. 180/65.265; 903/930; 180/65.28; 180/65.285

(57) ABSTRACT

A method and a device for controlling a drive train of a vehicle, in particular a hybrid vehicle, are described. The drive train includes at least two drive units. The one drive unit is an internal combustion engine, the other is an additional motor. A temperature value is recorded, which represents the exhaust-gas temperature of the internal combustion engine. The component for generating the drive torque with the aid of the additional motor is adjusted as a function of the exhaust-gas temperature, such that at higher exhaust-gas temperatures a greater component of the drive torque is generated with the aid of the additional motor than at lower exhaust-gas temperatures.

### FIELD OF THE INVENTION

The present invention relates to a method for controlling a drive train of a vehicle, in particular a hybrid vehicle, having at least one internal combustion engine.

### BACKGROUND INFORMATION

Hybrid vehicles are equipped with at least two drive units. In most cases, an internal combustion engine and at least one electrical machine are used as drive units. However, alternative drive units such as gas engines or hydraulic motors are conceivable as well. The subject matter of the exemplary embodiments and/or exemplary methods of the present invention is a drive train having at least two drive units, one of which is meant to be an internal combustion engine, and the other, an additional motor. The entire drive torque of the drive train is composed of the torque of the internal combustion engine and the additional motor, in particular an electric machine.

German patent document DE 10 2005 039 316 discusses a hybrid vehicle and a corresponding drive train, in which the drive units are controlled as a function of the exhaust-gas temperature. For higher loads, and thus for more rapid heating of the internal combustion engine, the electric machine is operated as generator. This shortens the duration of the warm-up operation of the internal combustion engine, during which especially high emissions are produced. To protect the catalyst from excessive thermal loading, the related art describes an operation of the internal combustion engine at an enriched engine Lambda value. An air/fuel mixture which has a higher fuel component than required for realizing the requested output is employed. This method for protecting the catalyst in terms of temperature is also referred to as component protection. The enriching of the air/fuel mixture for component protection leads to considerably higher fuel consumption than would be necessary for an operation at the requested output.

### SUMMARY OF THE INVENTION

The method according to the present invention and the device having the features of the independent claims utilize the possibilities of the hybrid drive for protecting the catalyst from excessive temperatures while not increasing the fuel consumption in the process, if possible. According to the exemplary embodiments and/or exemplary methods of the present invention, a drive train of a vehicle, especially a drive train of a hybrid vehicle, is controlled. The drive train has at least one internal combustion engine and at least one additional motor, particularly an electric machine, for the partial generation of the drive torque in each case. An arrangement is provided to record the temperature value that represents an exhaust-gas temperature of the internal combustion engine. The component for generating the drive torque with the aid of the additional motor is varied as a function of the exhaust-gas temperature. According to the exemplary embodiments and/or exemplary methods of the present invention, at higher exhaust-gas temperatures, a higher portion of the drive torque is generated with the aid of the additional motor than at lower exhaust-gas temperatures.

The technical background is that a catalyst must be protected against excessive exhaust-gas temperatures. In full-load operation, in particular, the exhaust gases reach their highest temperatures. By reducing the torque request from the internal combustion engine and simultaneously increasing the torque of the electric machine, the full-load operation of the internal combustion engine is avoided in the hybrid vehicle and the exhaust-gas temperature is lowered as a result.

The advantages of the exemplary embodiments and/or exemplary methods of the present invention are the lowering of the exhaust-gas temperatures on the one hand, so that the catalyst does not suffer damage, and the fact that an enrichment of the air/fuel mixture does not increase the fuel consumption on the other.

In another development of the exemplary embodiments and/or exemplary methods of the present invention, the component for generating the drive torque with the aid of the additional motor is increased when a temperature-threshold value is exceeded.

The technical background is that the requested torque of the internal combustion engine is reduced at a critical temperature, so that the exhaust-gas temperature is lowered and the electric machine compensates for the correspondingly reduced torque.

The advantage of this embodiment of the present invention is that it requires no continuous control; instead, the increase of the component for generating the drive torque is controlled by the additional motor as a result of the exceeding of a temperature threshold.

In one further development of the present invention, monitoring of an energy-store unit for the engine takes place in addition. If the motor is represented by an electric machine, then this energy-store unit corresponds to an electric battery. The increase in the component for generating the drive torque with the aid of the additional motor is then implemented as a function of a charge state of the energy-store unit.

The technical background is that the motor must be supplied by an available energy. Only if the charge state of the energy-store unit is sufficient will the motor be able to deliver the requested additional torque.

The advantage of this development of the exemplary embodiments and/or exemplary methods of the present invention is that the charge state of the storage unit is taken into account.

One additional development of the present invention is characterized by the fact that at a low charge state, particularly when a threshold value of the charge state of the energy-store unit (211) is not attained, the internal combustion engine (202) is operated using an enriched air/fuel mixture.

The technical background is that the operational readiness of the additional motor is taken into account by querying the charge state. If the drive torque of the additional motor is not available due to the charge state of the energy storage unit, then the temperature restriction of the exhaust gas is implemented by enriching the air/fuel mixture of the internal combustion engine. An air/fuel mixture having a higher fuel component is employed. This reduces the exhaust-gas temperatures significantly.

The advantage of this development is that it provides an operating strategy in the event that the energy storage unit for the motor shows an insufficient charge state.

In one additional development of the exemplary embodiments and/or exemplary methods of the present invention, the internal combustion engine is simultaneously operated with an enriched air/fuel mixture in order to increase the component for generating the drive torque with the aid of the additional motor.

The technical background is that in this case both the motor and the internal combustion engine contribute to the restriction of the exhaust-gas temperature.

The advantage of this development is that especially at an average or low charge state of the battery, a contribution to the restriction of the exhaust-gas temperature is made both by the additional motor and by the enrichment of the air/fuel mixture, the increase in the fuel consumption being minimized.

In one further development of the exemplary embodiments and/or exemplary methods of the present invention, the internal combustion engine is simultaneously operated using a leaner air/fuel mixture in order to increase the component for generating the drive torque with the aid of the additional motor. The fuel portion of the air/fuel mixture is reduced in order to produce the leaner fuel/air mixture.

The technical background is that in this case the internal combustion engine supplies less drive torque because of the leaner air/fuel mixture. This leads to a drop in the exhaust-gas temperature of the internal combustion engine.

The missing drive torque is compensated for by an increase in the component for generating the drive torque with the aid of the additional motor. Thus, both the motor and the internal combustion engine contribute to the restriction of the exhaust-gas temperature.

The advantage of this development is that especially at an average or low charge state of the battery, a contribution to the restriction of the exhaust-gas temperature is made both by the additional motor and by the reduction of the fuel component of the air/fuel mixture, the increase in the fuel consumption being minimized.

In one further development of the exemplary embodiments and/or exemplary methods of the present invention, the output of the internal combustion engine is simultaneously reduced with the aid of a power-regulating actuator in order to increase the component for generating the drive torque with the aid of the additional motor. The power-regulating actuator may be represented especially by a throttle valve in the case of a gasoline engine. In a diesel engine, the power-regulating actuator may be represented by a fuel injector, in particular. But it is also conceivable to use other power-regulating actuators for an internal combustion engine. This reduces the charge in the combustion chamber, in particular.

The technical background is that in this case the internal combustion engine supplies less drive torque, especially because of a lower charge in the combustion chamber. This leads to a drop in the exhaust-gas temperature of the internal combustion engine. The missing drive torque is compensated for by increasing the component for generating the drive torque with the aid of the additional motor. Thus, both the motor and the internal combustion engine contribute to the restriction of the exhaust-gas temperature.

The advantage of this development is that especially at an average or low charge state of the battery, both the additional motor and the reduction of the fuel component of the air/fuel mixture contribute to the restriction of the exhaust-gas temperature, the increase in the fuel consumption being minimized.

Exemplary embodiments of the present invention are shown in the drawing and explained in greater detail in the following description.

### BRIEF DESCRIPTION OF THE DRAWINGS

FIG. 1 shows a method for controlling a drive train of a vehicle.

FIG. 2 shows a device for controlling a drive train of a vehicle.

### DETAILED DESCRIPTION

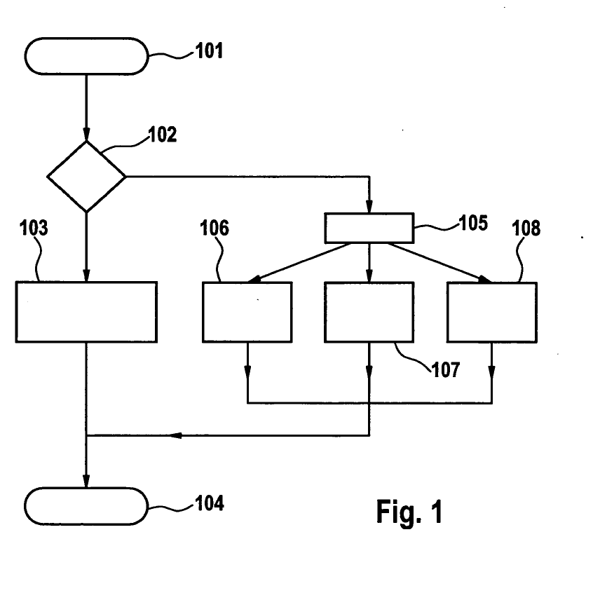

FIG. 1 shows a method for controlling a drive train of a vehicle. The method starts with step 101. In step 102, it is checked whether the recorded temperature of the exhaust gas exceeds a threshold value. If the threshold value is not exceeded, the drive units are operated on the basis of the regular operating strategy, as shown in step 103. The method ends by step 104. If the temperature of the exhaust gas exceeds a threshold value in step 102, then branching of the method takes place in order to prevent a further rise in the temperature. In the following step 105, the charge state of the battery is checked in order to be able to decide which further strategy could prevent the rise in the temperature of the exhaust gas. If the charge state of the battery is high in step 105, then the component for generating the drive torque with the aid of the additional motor is increased in step 106 and a further rise in the temperature of the exhaust gas prevented in this manner. If the battery has an average charge state in step 105, then the component for generating the drive torque with the aid of the additional motor is slightly increased in step 107, and the component for generating the drive torque with the aid of the internal combustion engine is slightly reduced at the same time, it then being operated using a richer air/fuel mixture. As a result, the further rise of the temperature of the exhaust gas is likewise prevented. If the charge state of the battery is low in step 105, then the component for generating the drive torque by way of the additional motor will not be increased in step 108, and a richer air/fuel mixture is supplied to the internal combustion engine. Thus, the further rise of the temperature of the exhaust gas is prevented in such a case as well. The subsequent step to steps 106, 107, and 108 is step 104, by which the method is terminated. The repetition of the method steps produces an iterative closed-loop control circuit. Thus, the increase of the temperature of the exhaust gas to temperatures that in damage components is able to be prevented in a reliable manner.

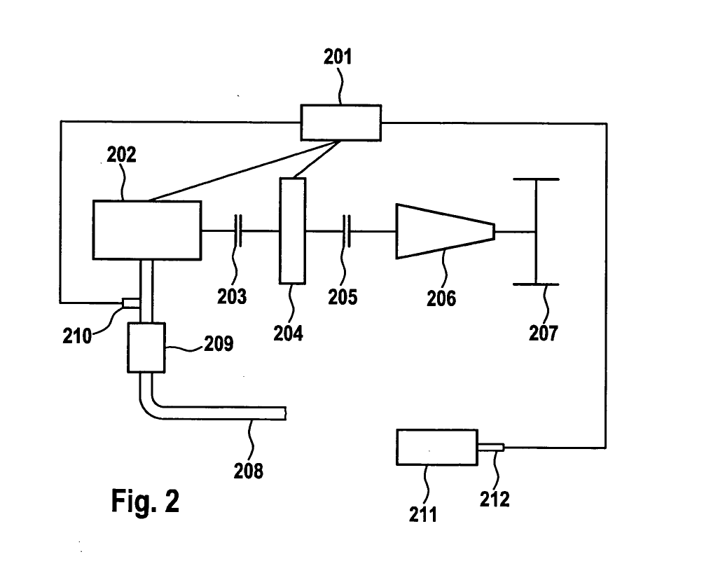

FIG. 2 shows a device for controlling a drive unit of a vehicle. 202 represents the internal combustion engine of the drive train, 204 represents the electric machine, 206 the transmission, and 207 the powered axle having the drive wheels of the drive train of the hybrid vehicle. Clutches 203 and 205 may be mounted between the internal combustion engine and the electric machine, and also between the electric machine and the transmission. Exhaust-gas tract 208 includes a catalyst 209 and a temperature-sensor system 210. An energy-store unit 211 is provided for the electric machine. The charge state of the battery is detected by sensor 212. Device 201 controls drive units 202 and 204 as a function of the recorded signals of sensors 210 and 212, which have been evaluated with the aid of methods, in particular.

1-9. (canceled)

10. A method for controlling a drive train of a hybrid vehicle having at least one internal combustion engine and at least one additional motor for providing individual partial generation of a drive torque, comprising:
detecting a temperature value representing the exhaust-gas temperature of the internal combustion engine; and
adjusting a component for generating the drive torque with the aid of the additional motor a function of the exhaust-gas temperature, such that at higher exhaust-gas temperatures a greater component of the drive torque is generated with the aid of the additional motor than at lower exhaust-gas temperatures.

11. The method of claim 10, wherein the component for generating the drive torque with the aid of the additional motor is increased when a temperature-threshold value is exceeded.

12. The method of claim 10, wherein the motor is an energy-store unit, and wherein the increase in the component for generating the drive torque with the aid of the additional motor is implemented as a function of a charge state of the energy-store unit.

13. The method of claim 12, wherein at a low charge state, when falling below a threshold value of the charge state, and wherein the energy-store unit of the internal combustion engine is operated using an enriched air/fuel mixture.

14. The method of claim 10, wherein the component for generating the drive torque with the aid of the additional motor is increased, and wherein the internal combustion engine is operated using an enriched air/fuel mixture at the same time.

15. The method of claim 10, wherein the component for generating the drive torque with the aid of the additional motor is increased, and wherein the internal combustion engine is operated using a leaner air/fuel mixture at the same time.

16. The method of claim 10, wherein the motor is a power-regulating actuator, wherein the component for generating the drive torque with the aid of the additional motor is increased, and wherein the output of the internal combustion engine is reduced by a power-regulating actuator at the same time.

17. A device for controlling a drive train of a hybrid vehicle having at least one internal combustion engine and at least one additional motor for the individual partial generation of the drive torque, comprising:
a temperature sensor system to measure an instantaneous temperature; and
an arrangement to increase the component for generating the drive torque with the aid of the additional motor as a function of the instantaneous temperature.

18. The device of claim 17, further comprising:
a further arrangement to increase the component for generating the drive torque with the aid of the additional motor as a function of a charge state of an energy-store unit, wherein the motor is the energy-store unit.
